(19) United States
(12) Patent Application Publication
(10) Pub. No.: US 2025/0289213 A1
(43) Pub. Date: Sep. 18, 2025

(54) SYSTEMS AND METHODS FOR FORMING LAMINATE COMPOSITE STRUCTURES

(71) Applicants: Michael Christopher Maher, III, Forest Hill, MD (US); Michael Christopher Maher, IV, Greenville, SC (US)

(72) Inventors: Michael Christopher Maher, III, Forest Hill, MD (US); Michael Christopher Maher, IV, Greenville, SC (US)

(21) Appl. No.: 18/606,295

(22) Filed: Mar. 15, 2024

(51) Int. Cl. B32B 37/18; B32B 37/00; B32B 37/06; B32B 37/10; B32B 37/12

(52) U.S. Cl. CPC B32B 37/18; B32B 37/0046; B32B 37/06; B32B 37/10; B32B 37/1207; B32B 2305/22; B32B 2310/028

(57) ABSTRACT

Systems, methods, schemes, techniques and processes are provided for forming laminate composite structures, including by implementing a unique ultrasonic fabrication support process to enhance interstitial interaction and strength between adjacent laminate composite layers and structures, realizing resultant improvements in structural strength and reliability against mixed mode failures in the fabricated laminate composite structures by exciting Z-aligned fibers in composite materials to be energized in an manner that facilitates at least contact or partial penetration of adjoining layers and structures with the energized Z-aligned fibers to create stronger and more reliable mechanical and structural bonds therebetween.

### BACKGROUND

### 1. Field of the Disclosure

This disclosure is directed to exemplary embodiments of systems, methods, schemes, techniques and processes for forming laminate composite structures, including by implementing a unique ultrasonic fabrication support process to enhance interstitial interaction and strength between adjacent laminate composite layers and structures, realizing resultant improvements in structural strength and reliability against mixed mode failures in the fabricated laminate composite structures.

### 2. Description of the Related Art

Laminate composites and laminate composite structures are known. Laminate composite material layers, typically adhered together with conventional adhesives and static or activated resin matrices, are widely employed in myriad structures and structural employment scenarios, particularly where weight savings and structural reliability are essential. Examples of such structural employment scenarios include, but are not limited to, aircraft structural components, windmill blades, armoring panels and the like.

Laminate composite structures are typically formed of layers, or stratums, of woven fibers. In common fabrication modes, multiple layers of thin fabric woven fiber layers, whose fibers may, for example, comprise of inorganic and organic constituents, such as carbon, glass, and polyaramid fibers, are typically stacked one upon another, and adhered to each other, and overall, with interstitially interposed adhesives or resin matrices. Combinations of heat and pressure are typically applied to activate and facilitate the processes for interconnecting the fiber fabric layers so as to form hardened laminate composite structures.

The aerospace industry, in particular, has found benefit in the use of what are commonly called “pi joints” as assembly techniques for interconnecting primary structures. The transition to such advanced fabrication methods has seen the benefits of reducing weight in final structures, and of reducing costs in the fabrication of these structures. The pi joint has become notoriously well known, for example, as a woven preform co-bonded between skins and stringers.

While these joints are considered inherently weight-effective for highly loaded structural applications, the fabrication processes for structures including these joints tend to be susceptible to a number of identifiable shortfalls including, but not limited to, process-related variations that may adversely affect structural strength, and introduce certain other nonconformance issues. Examples of identified fabrication process-related variations that have the potential to adversely affect the strength and/or conformance of the finished structures including such joints may be related to one or more of variable porosity of the structural components, resin pooling, and thickness variations in resin layers.

The above-indicated issues may manifest themselves in a form of mixed mode failures causing unacceptable scatter, or unpredictability, in mechanical performance of the finished structures, failures within which may result and which may be completely unforeseen.

Depending on the specific application in which the laminate composite structures and/or pi joints are to be employed, the above-indicated variations may effectively result in a reduction in the structural design allowables causing the finished structures to be over-engineered in order to account for the variability. This reduction may have the effect of, for example, resulting in heavier-than-necessary designs for the finished structures. As an overall consequence of the current “inherent” variability, current fabrication methods and processes, even employing advanced adhesives and/or resin matrices, are not able to be employed to their potentially realizable engineering limits based principally on the existence of some uncertainty in the quality of the bonded joints.

Of concern is that a perceived (or demonstrated) lack of reliability in the laminate composite structures, including pi joints, fabricated according to current conventional methods adversely affects trust in those structures and/or joints. This perception, borne out in cases by evidence of actual failure (including muti-mode failure), is believed to have slowed further adoption of laminate composite structural components fabricated according to existing methods in a variety of applications, including and perhaps most specifically in aircraft applications, where failure may prove catastrophic.

### SUMMARY OF THE DISCLOSED EMBODIMENTS

In view of what is believed to be a clear need to address the above-identified shortfalls in current manufacturing systems, methods, schemes, techniques and processes for laminate composite structures, improvements may be implemented in a manner that may capitalize on the benefits realized from advanced fabrication methods, while reducing or eliminating any attendant risks of potential multi-mode failure.

These improvements may engender a greater level of confidence in the strength and durability of the resultant laminate composite structures without sacrificing potential weight savings. In this regard, it would be advantageous to provide a fabrication method particularly tailored to achieve greater strength, particularly at the interstices between laminate composite layers and/or internal structures, thereby promoting higher levels of overall confidence in the reliability of, and load sharing capacity realized with, and within, the fabricated laminate composite structures.

Exemplary embodiments according to this disclosure are intended, among other objectives, to address any or all of the weaknesses detailed above as recognized shortfalls in the prior art.

Exemplary embodiments may improve reliability by addressing differing manners by which sources of variation conventionally manifest themselves in producing mixed mode failures in fabricated laminate composite structures (including internal to those laminate composite structures), and at joints between fabricated laminate composite structures, including at least cohesive, adhesive, and surface ply failures.

Exemplary embodiments may employ innovative, aligned discontinuous fiber material formats. For reference in this disclosure, fiber material layers are characterized as extending substantially in planar directions (specified in the X and Y directions) with particular fiber components extending orthogonally (or “vertically”) from the principal plane of the fiber material layer, i.e., in a Z direction with respect to the X-Y plane of the fiber layer. Examples of such materials are available from commercial sources. For consistency in interpretation, this disclosure will refer to these out of plane substantially orthogonally extending fiber components as “Z-aligned” fibers and fiber components.

Exemplary embodiments may “excite” the Z-aligned fibers in a unique manner such that when layers of the fiber material, or structures including such layers, are brought into contact with adjacent layers or structures in the fabrication processes the Z-aligned fibers are caused, by one or more external-applied forces, to remain substantially “erect.” Such forces may cause the Z-aligned fibers to vibrate while substantially maintaining their orientation. In this manner, substantial numbers of the Z-aligned fibers of a first layer or structure may make structurally-beneficial contact with, or at least partially penetrate, the surfaces of second layers or structures with which the first layer or structure are brought into contact in the overall structure fabrication process.

Exemplary embodiments may apply external forces to excite the Z-aligned fibers to vibrate those fibers for at least a portion of the fabrication process in a manner that is not conventionally available.

Exemplary embodiments may employ externally-applied ultrasonic vibrations as a mechanism or motivating force by which to excite the Z-aligned fibers to remain in an orthogonal or Z-direction orientation, and/or to vibrate and enable laminate/structure consolidation in the Z-direction.

As will be described in detail below, exemplary embodiments may provide unique ultrasonic excitation systems, methods, schemes, techniques and processes to facilitate the excitation of the Z-aligned fibers as the layers and/or structures are brought into contact to facilitate at least partial penetration or contact of adjoining layers or structures by cooperating Z-aligned fibers therebetween.

Exemplary embodiments may thus improve the overall structural strength and durability of, and within, adjoining laminate composite layers and structures over the structural strength and durability of such cooperating layers and structures afforded by conventional adhesives, resin matrices, and adhesion methods therebetween.

Exemplary embodiments may create toughened interfaces at bond lines, and between plies (or layers) of laminate composite layers and structures.

These and other features, and advantages, of the disclosed systems, methods, schemes, techniques and processes are described in, or apparent from, the following detailed description of various exemplary embodiments.

### BRIEF DESCRIPTIONS OF THE DRAWINGS

Various exemplary embodiments of the disclosed systems, methods, schemes, techniques and processes for forming laminate composite structures, including by implementing a unique ultrasonic manufacturing process to enhance interstitial interaction and strength between adjacent laminate composite layers and structures according to this disclosure, will be described, in detail, with reference to the following drawings, in which:

FIG. 1A schematically illustrates a diagram of an exemplary embodiment of a substantially planar aspect, or view, of a laminate composite layer or structure extending in an X direction and in a Y direction, according to this disclosure;

FIG. 1B schematically illustrates a diagram of an exemplary embodiment of an edge aspect, or view, of the laminate composite layer or structure shown in FIG. 1A, showing particular fiber components extending orthogonally (or “vertically”) from the plane of the laminate composite layer or structure, i.e., in a Z direction with respect to the X-Y plane of the laminate composite layer or structure, “Z-aligned fibers” as used in this disclosure;

FIG. 2A schematically illustrates a diagram of an exemplary first step in a fabrication method, scheme, technique or process for laminate composite layers or structures according to this disclosure;

FIG. 2B schematically illustrates a diagram of an exemplary second step in a fabrication method, scheme, technique or process for laminate composite layers or structures according to this disclosure;

FIG. 2C schematically illustrates a diagram of an alternative exemplary second step in a fabrication method, scheme, technique or process for laminate composite layers or structures according to this disclosure;

FIG. 2D schematically illustrates a diagram of an exemplary third step in a fabrication method, scheme, technique or process for laminate composite layers or structures according to this disclosure;

FIG. 2E schematically illustrates a diagram of an exemplary fourth step in a fabrication method, scheme, technique or process for laminate composite layers or structures according to this disclosure;

FIG. 2F schematically illustrates a diagram of an exemplary fifth step in a fabrication method, scheme, technique or process for laminate composite layers or structures according to this disclosure;

FIG. 2G schematically illustrates a diagram of an exemplary sixth step in a fabrication method, scheme, technique or process for laminate composite layers or structures according to this disclosure;

FIG. 2H schematically illustrates a diagram of an exemplary seventh step in a fabrication method, scheme, technique or process for laminate composite layers or structures according to this disclosure;

FIG. 3A schematically illustrates a diagram of details of an exemplary first interaction between constituent layers or structures involved in a fabrication method, scheme, technique or process for laminate composite layers or structures according to this disclosure;

FIG. 3B schematically illustrates a diagram of details of an exemplary second interaction between constituent layers or structures involved in a fabrication method, scheme, technique or process for laminate composite layers or structures according to this disclosure;

FIG. 4 illustrates a flowchart of an exemplary method, scheme, technique or process for fabrication of complex laminate composite layers or structures according to this disclosure; and

FIGS. 5A and 5B respectively schematically illustrate a side view and a front view of details of an exemplary embodiment of an ultrasonic horn according to this disclosure.

### DETAILED DESCRIPTION OF THE INVENTION

The disclosed systems, methods, schemes, techniques and processes for forming laminate composite structures, including by implementing a unique ultrasonic manufacturing process to enhance interstitial interaction and strength between adjacent laminate composite layers and structures, may be realized by implementing varying combinations of features according to the disclosed exemplary embodiments.

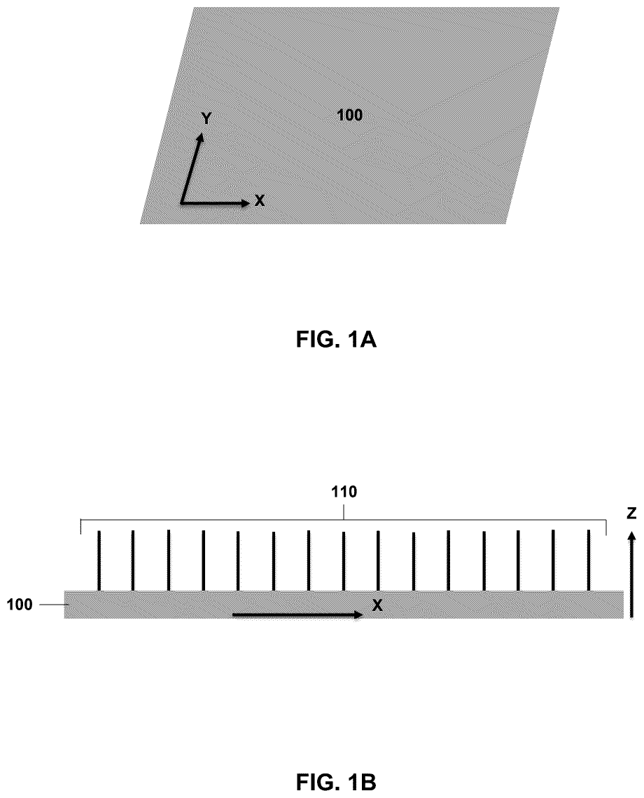

FIG. 1A schematically illustrates a diagram of an exemplary embodiment of a substantially planar aspect or view of a laminate composite layer or structure 100 extending in an X direction, and in a Y direction, according to this disclosure. FIG. 1B schematically illustrates a diagram of an exemplary embodiment of an edge aspect, or view, of the laminate composite layer or structure 100 shown in FIG. 1A, showing particular fiber components extending orthogonally (or “vertically”) from the plane of the laminate composite layer or structure, i.e., in a Z direction with respect to the X-Y plane of the laminate composite layer or structure, the Z-aligned fibers 110.

At least one particular materials manufacturer has developed a proprietary manufacturing system to produce discontinuous fiber materials in rolls and sheets up to, for example, 1 meter wide. It is understood that this particular materials manufacturer has achieved production status with the ability to manufacture up to one million square meters per year.

According to the manufacturing process, the finished products may comprise, for example, carbon fibers up to 3 mm in length that may be preferably spatially oriented in three dimensions using a known magnetic alignment technique. Unidirectionally-oriented discontinuous fibers may be fabricated that achieve key mechanical properties of continuous fiber materials, with added functionality of high drapability and high toughness.

In part, due to the fiber volume and inter-fiber attraction between Z-aligned fibers 110, the particular fiber components shown in exemplary manner in FIG. 1B as extending orthogonally (or “vertically”) from the plane of the laminate composite layer or structure 100, traditional curing mechanisms have generally failed in enabling the Z-aligned fibers 110 to contact, or otherwise interpenetrate, surrounding, facing or adjoining lamina or structures, resulting in no apparent structural benefit in through-thickness properties for a multi-layered structure.

In embodiments, the disclosed schemes may be advantageously applied, for example, to dry film layers that are on an order of 5 mils thick. In embodiments, dry fiber or resin impregnated fiber forms may be most advantageously applied in that the Z-aligned fibers extending therefrom may be particularly excitable, or actually excited, in maximizing any response to the application of an excitation energy, including ultrasonic energy in certain of the disclosed embodiments.

Development of disclosed exemplary embodiments involved experimentation with non-limiting combinations of materials including:
Adding a layer of Z-aligned fiber material between first and second cooperating plies on each side of a laminate, with and without applying external (ultrasonic) excitation; and
Adding a layer of Z-aligned fiber material between first and second plies, and between second and third plies on each side of a laminate, with and without applying external (ultrasonic) excitation.

As will be described in greater detail below, the disclosed systems, methods, schemes, techniques and processes may apply a unique excitation force to the Z-aligned fibers to maintain the substantially orthogonal (or vertical) orientation of these fibers while imposing a vibration that manifests structural benefit by promoting at least one of contact and partial penetration of the Z-aligned fibers with, or into, adjacent layers or structures with which the Z-aligned fibers are brought adjacent in the disclosed fabrication processes.

In exemplary embodiments, the unique excitation force may be in a form of ultrasonic energy emanating from a particular configuration of an ultrasonic horn that may be usable to facilitate increased interactions between the Z-aligned fibers and separate layers, or other structure components, that may be brought into contact with the Z-aligned fibers in the disclosed fabrication processes.

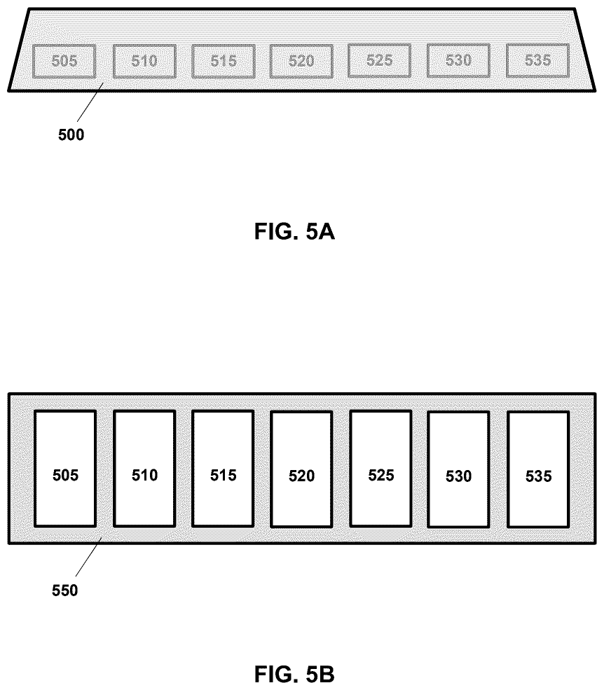

In embodiments, an exemplary ultrasonic horn may comprise a plurality of piezoelectric transducers (see, e.g., FIGS. 5A and 5B, and the descriptions of those Figures below) that may be usable creates minute, ultrasonic vibrations that can be applied to a material. Application of ultrasonic energy is known for such common uses as ultrasonic welding, heating, and mixing.

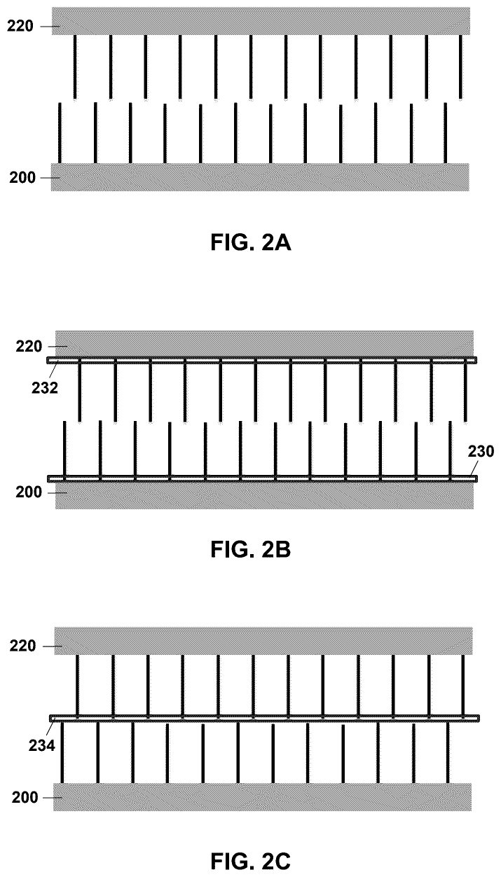

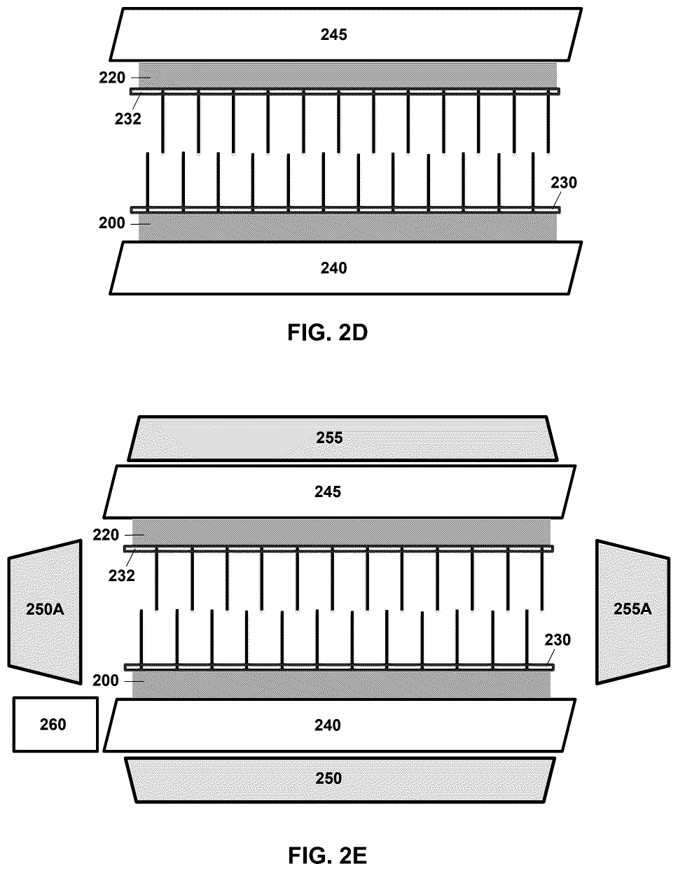

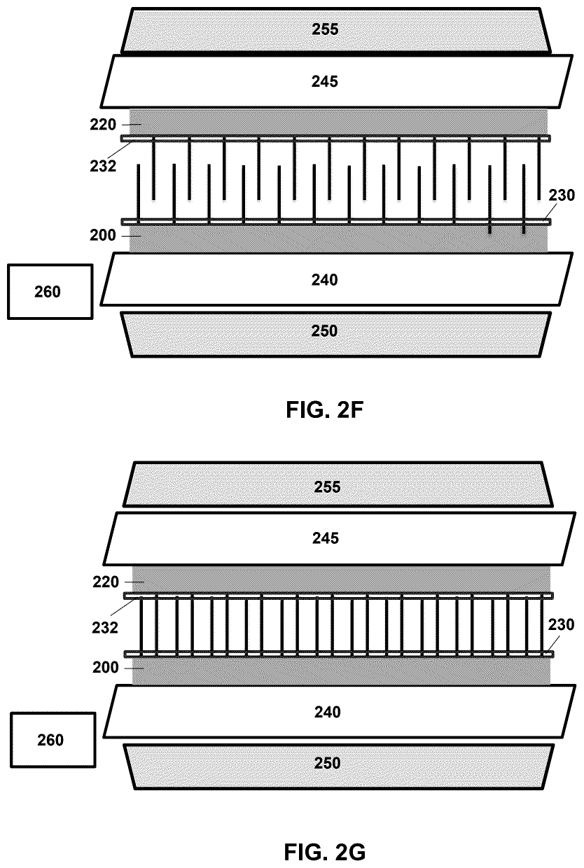

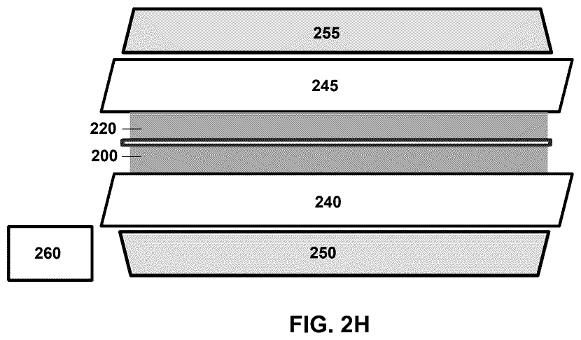

FIG. 2A schematically illustrates a diagram of an exemplary first step in a fabrication method, scheme, technique or process for laminate composite layers or structures according to this disclosure. As shown in FIG. 2A, a first layer (or structure) 200 with Z-aligned fibers projecting therefrom may be emplaced in the open, or in some manner of structure (not shown). A second layer (or structure) 220 (which may or may not have cooperating Z-aligned fibers projecting therefrom) may be aligned with the first layer (or structure) 200 such that a facing surface of the second layer (or structure) 220 faces the surface of the first layer (or structure) 200 from which the Z-aligned fibers are projecting.

FIG. 2B schematically illustrates a diagram of an exemplary second step in a fabrication method, scheme, technique or process for laminate composite layers or structures according to this disclosure. As shown in FIG. 2B, an adhesive (or resin matrix) 230 may be applied to a facing surface of the first layer (or structure) 200 from which the Z-aligned fibers project. Additionally, or alternatively, a same or separate adhesive (or resin matrix) 232 may be applied to the facing surface of a second layer (or structure) 220.

FIG. 2C schematically illustrates a diagram of an alternative exemplary second step in a fabrication method, scheme, technique or process for laminate composite layers or structures according to this disclosure. As shown in FIG. 2C, an adhesive (or resin matrix) 234 may be positioned at, or between, tips of the Z-aligned fibers.

FIG. 2D schematically illustrates a diagram of an exemplary third step in a fabrication method, scheme, technique or process for laminate composite layers or structures according to this disclosure. As shown in FIG. 2D, a combination of the first layer (or structure) 200 and the aligned second layer (or structure) 220, with one or more respective adhesives (or resin matrices) 230/232 applied or not, may be emplaced between mechanical urging members 240/245 in a fabrication processing device.

At least one of the mechanical urging members 240/245 may be movable with respect to the other of the mechanical urging members 240/245. Separately, at least one of the mechanical urging members 240/245 may be heat augmented with a heat source that may be usable to cooperatively apply heat to at least one of the first layer (or structure) 200 and the aligned second layer (or structure) 220 for activation of one or more of the adhesives (or resin matrices) 230/232 (when applied), in the fabrication process.

FIG. 2E schematically illustrates a diagram of an exemplary fourth step in a fabrication method, scheme, technique or process for laminate composite layers or structures according to this disclosure. As shown in FIG. 2E, at least one fiber excitation (ultrasonic) device 250/255 may be introduced. In embodiments, at least one fiber excitation (ultrasonic) device 250/255 may be positioned to excite the Z-aligned fibers in a lengthwise direction. Additionally, or alternatively, at least one fiber excitation (ultrasonic) device 250A/255A may be positioned to excite the Z-aligned fibers in a transverse direction.

For ease of depiction and understanding, the following depictions and descriptions will be limited to embodiments in which the at least one fiber excitation (ultrasonic) device 250/255 is be positioned to excite the Z-aligned fibers in a lengthwise direction. These depictions and descriptions should not be considered to in any way preclude positionings of at least one fiber excitation (ultrasonic) device in any other, or alternative aspect with respect to the Z-aligned fibers.

The at least one fiber excitation (ultrasonic) device 250/255 (or 250A/255A, or otherwise in any other aspect) may be in a form of a particularly-configured ultrasonic horn (which term will be alternatively used throughout this disclosure to describe a particular exemplary embodiment of the at least one fiber excitation (ultrasonic) device 250/255 (or 250A/255A, or otherwise) usable to impart particular excitation energy to the Z-aligned fibers according to the disclosed methods). The at least one fiber excitation (ultrasonic) device 250/255 (or 250A/255A, or otherwise) may be an integral component of a fabrication processing device, including the mechanical urging members 240/245, or may be a separate member apart from the fabrication processing device.

A controller 260 may be provided to control at least one of (a) operation of the mechanical urging members 240/245 toward one another (and the heating of one or more of the mechanical urging members 240/245, as appropriate) and/or operation of the at least one fiber excitation (ultrasonic) device 250/255 (and/or 250A/255A, or otherwise).

The controller 260 may be particularly advantageously employed in adjusting the characteristics of the ultrasonic energy and/or waveform emitted from the at least one fiber excitation (ultrasonic) device 250/255 (or 250A/255A, or otherwise). These characteristics of the emitted ultrasonic energy may include, for example, emitted power, wave form, frequency, and exposure time with regard to the emanated ultrasonic energy.

In development, a frequency of, for example, 30 kHz was determined to be effective in eliciting the desired response from the Z-aligned fibers, while still being controllable. There is substantially no limitation to the operative frequencies of the emitted ultrasonic energy, although it may be observed that (a) at significantly higher frequencies the Z-aligned fibers may be, less than optimally, moved “too much,”, and (b) at significantly lower frequencies the Z-aligned fibers may not respond well enough to the attempted ultrasonic excitation to facilitate contact with, or penetration of, adjoining layers or structures, as depicted in certain of the following, as discussed in greater detail below. Typical power/energy levels may be adjusted by the controller 260 to be in ranges of, for example, 25-35W and 230-260J. Again here, these ranges are exemplary only, and should not considered limiting. Particular embodiments may find adequate response, in the form of Z-aligned fiber excitation, beyond the limits of these specified ranges.

In embodiments, in this step, and in the steps that follow through the completion of the fabrication process, vibratory energy may be applied by the controller 260 energizing one or more of the ultrasonic horns 250/255 (or 250A/255A, or otherwise). In embodiments, the vibratory energy may be applied to the Z-aligned fibers at a bond line between the layers (or structures) 200/220 to be joined and/or at interlaminar interfaces between the layers (or structures) 200/220. Ultrasonic energy frequencies, and a size and/or shape of the ultrasonic horns, may be adjustable or modified to create optimal vibratory energy to facilitate fiber contact or insertion according to the variability in the materials used for the layers (or structures) 200/220, and for the adhesives (or resin matrices) 230/232/234.

FIG. 2F schematically illustrates a diagram of an exemplary fifth step in a fabrication method, scheme, technique or process for a laminate composite layer or structure according to this disclosure. As shown in FIG. 2F, with at least one of the fiber excitation (ultrasonic) devices 250/255 energized to impart excitation energy, in a form of ultrasonic energy or otherwise, at least one of the mechanical urging members 240/245 may be moved relative to the other to urge the first layer (or structure) 200 and the aligned second layer (or structure) 220 toward each other in the fabrication process. As is indicated throughout this disclosure, the application of the excitation energy is intended to keep the Z-aligned fibers protruding from at least one of the first layer (or structure) 200 and the aligned second layer (or structure) 220 comparatively rigid and substantially orthogonal through the steps of the fabrication process.

FIG. 2G schematically illustrates a diagram of an exemplary sixth step in a fabrication method, scheme, technique or process for a laminate composite layer or structure according to this disclosure. As shown in FIG. 2G, with at least one of the fiber excitation (ultrasonic) devices 250/255 energized to impart excitation energy, in a form of ultrasonic energy or otherwise, at least one of the mechanical urging members 240/245 may continue its movement relative to the other to urge the first layer (or structure) 200 and the aligned second layer (or structure) 220 toward each other in the fabrication process such that now ends or tips of the excited Z-aligned fibers protruding from at least one of the first layer (or structure) 200 and the aligned second layer (or structure) 220 are made to contact or penetrate a facing surface of the the first layer (or structure) 200 and the aligned second layer (or structure) 220 in the fabrication process. The objective may be described as: at particular wavelengths/frequencies, the Z-aligned fibers may be caused to vibrate, allowing them to move past one another and drive inter-penetration of the opposing layers or structures.

FIG. 2H schematically illustrates a diagram of an exemplary seventh step in a fabrication method, scheme, technique or process for a laminate composite layer or structure according to this disclosure. As shown in FIG. 2H, the at least one of the mechanical urging members 240/245 may have substantially completed its movement relative to the other such that the one or more adhesives (or resin matrices) now completely fill the interstitial space between the first layer (or structure) 200 and the aligned second layer (or structure) 220. To whatever extent the contact or inter-penetration of the excited Z-aligned fibers is going to occur, that process is now complete as well. In this manner, the described and depicted fabrication methods promote at least contact, or partial inter-penetration, by the Z-aligned fibers to create stronger and more reliable toughened interfaces between adjoining layers and/or structures as the layers/structures are urged in contact with one another in the manner shown in FIG. 2H.

In embodiments, increases in strength and reliability at the structural bond interfaces, over conventional adhesive or resin-matrix-based-adhesion-only methods, may result from contact with, or partial penetration of, opposing layers/structures by the Z-aligned fibers with an intermingling effect that may appear similar to that exhibited by, for example, known hook-and-pile fastening systems. In embodiments, this increase in interface toughness may also serve to increase bond strength and thickness properties between adjoining layers and/or structures.

Improved through-thickness properties between adjoining layers and/or structures may drive possible failure mechanics deeper into a laminate stack or structure fabricated according to the disclosed methods. Reductions in variations in failure modes may serve to reduce scatter in failure strength data in particular classes of laminate composite structures.

Experimentation has demonstrated that ultrasonic energy is an effective excitation force usable to drive Z-aligned fibers to interact with other adjacent laminate and pi preform fibers. Moreover, experimental results indicated a potential increase in lap shear strength of a system or structure fabricated according to disclosed embodiments by 15%, and a potential increase in through-thickness tension of at least 13%. With the increased properties, the only observed failure modes exhibited during extensive experimentation were failures deep in the skin laminate, thereby eliminating what may reasonably be considered a major source of variation previously exhibited and observed in conventionally-fabricated pi joint specimens.

In development, advantages were observed in the interaction between Z-aligned fiber plies and adjacent plies with regard to thickness measurements in those structures in which ultrasonics were applied according to the disclosed schemes. For example, using Z-aligned fiber layers having a thickness on an order of 5 mils, the average observed increase in thickness of the in-process fabricated structure was on average 1.6-2.0 mils for each layer added with ultrasonic excitation applied in the layer-to-layer fabrication process, as compared to an average increase of 2.8-3.8 mils for each layer added absent ultrasonic excitation.

Even in instances where limited Z-aligned fiber contact or penetration occurs in adjacent layers or structures, other advantages have been recognized. For flexural testing, there was an observed increase in strength of as much as 21% with 2 Z-aligned fiber plies when ultrasonic excitation was advantageously applied, and increased by as much as 17% with 4 Z-aligned fiber plies with ultrasonic excitation according to this disclosure applied. Separately, significant reductions in scatter were observed, including a 47% reduction in standard deviation for panels with 2 layers of Z-aligned fiber plies, and a 38% reduction for panels with 4 layers of Z-aligned fiber plies. Another observation in flexural testing was a significant reduction in mixed failures modes, as test specimens fabricated according to the disclosed methods substantially all failed in the skins beneath those including the Z-aligned fibers. Such reasonably more predictable failure modes, coupled with the observed reductions in scatter may prove beneficial (even crucial) to meeting an objective of creating a more reliable laminated composite structure, including, but not limited to, at bonded joints. Finally, for shear testing, increases in strength of as much as 14% with 2 Z-aligned fiber plies and 25% with 4 Z-aligned fiber plies were observed when fabricated according to the disclosed ultrasonic excitation methods.

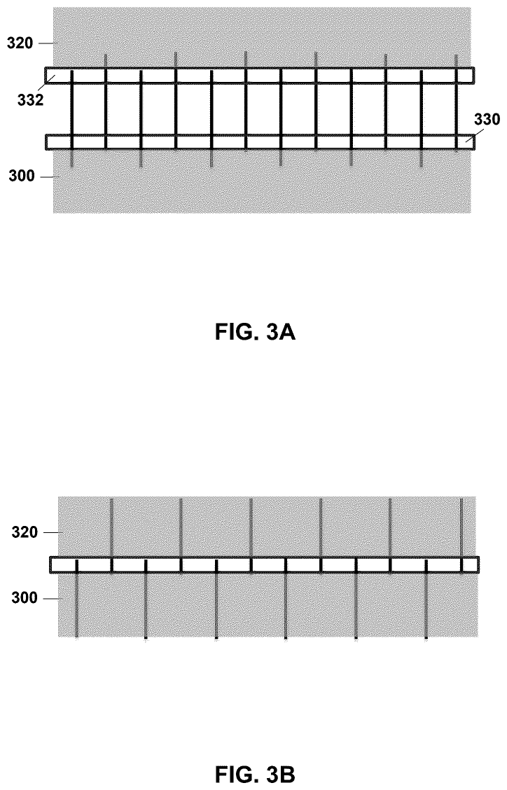

FIG. 3A schematically illustrates a diagram of details of an exemplary first interaction between constituent layers involved in a fabrication method, scheme, technique or process for a laminate composite layer or structure according to this disclosure. FIG. 3B schematically illustrates a diagram of details of an exemplary second interaction between constituent layers involved in a fabrication method, scheme, technique or process for a laminate composite layer or structure according to this disclosure.

FIGS. 3A and 3B are provided respectively to show details of the Z-aligned fiber interaction with the opposing surfaces as shown and described above with respect to FIGS. 2G and 2H (the 200 series numbers above being replaced with 300 series numbers here). As shown in FIG. 3A, with fiber excitation energy applied, ends or tips of the excited Z-aligned fibers protruding from at least one of the first layer (or structure) 300 and the aligned second layer (or structure) 320 are made to contact and/or penetrate a facing surface of the opposing layer (or structure) in the fabrication process while the adhesive (or resin matrix) layers 330/332 remain separated. As shown in FIG. 3B, the one or more adhesives (or resin matrices) now completely fill the interstitial space between the first layer (or structure) 300 and the aligned second layer (or structure) 320. To whatever extent the inter-penetration of the excited Z-aligned fibers is going to occur, that process is now complete as well.

Although depicted as complete penetration with respect to the depicted respective Z-aligned fibers through the opposing layers (or structures), it should be recognized that, while this may be considered only one potential solution, it is rarely going to occur and is therefore only shown for illustrative purposes. Any level of contact and/or inter-penetration of the Z-aligned fibers, and/or intermingling of those fibers, in levels that were previously unachieved and generally considered unachievable, will achieve the objectives of the disclosed methods to create stronger and more reliable toughened interfaces between adjoining layers and/or structures as the layers/structures are urged in contact with one another in the manner shown in FIG. 3B.

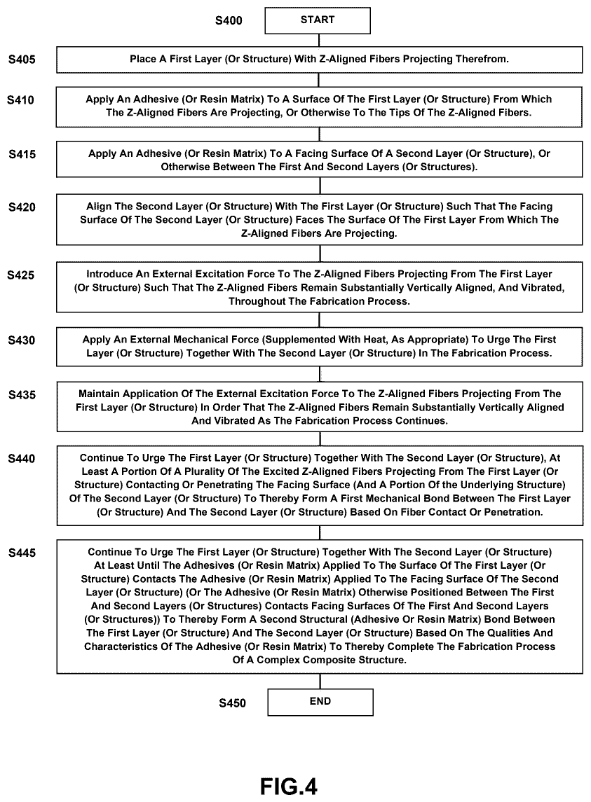

FIG. 4 illustrates a flowchart of an exemplary method, scheme, technique or process for fabrication of a complex laminate composite layer or structure according to this disclosure. As shown in FIG. 4, operation of the method commences at Step 400 and proceeds to Step S405.

In Step S405, a first layer (or structure) with Z-aligned fibers projecting therefrom may be emplaced on a surface. Operation of the method may proceed to Step S410.

In Step S410, an adhesive (or resin matrix) may be applied to a surface of the first layer (or structure) from which the Z-aligned fibers project, or otherwise to the tips of the projecting Z-aligned fibers. Operation of the method may proceed to Step S415.

In Step S415, an adhesive (or resin matrix) may be applied to a facing surface of a second layer (or structure), or otherwise between the first layer (or structure) and a second layer (or structure). Operation of the method may proceed to Step S420.

In Step S420, the second layer (or structure) may be aligned with the first layer (or structure) such that the facing surface of the second layer (or structure) faces the surface of the first layer from which the Z-aligned fibers are projecting. Operation of the method may proceed to Step S425.

In Step S425, an external excitation force may be introduced to the Z-aligned fibers projecting from the first layer (or structure) such that the Z-aligned fibers remain substantially vertically aligned, and may be vibrated, throughout the fabrication process. Operation of the method may proceed to Step S430.

In Step S430, an external mechanical force (supplemented with heat, as appropriate) may be applied to urge the first layer (or structure) together with the second layer (or structure) in the fabrication process. Operation of the method may proceed to Step S435.

In Step S435, application of the external excitation force to the Z-aligned fibers projecting from the first layer (or structure) may be maintained throughout the fabrication process in order that the Z-aligned fibers may remain substantially vertically aligned, and may be vibrated, as the fabrication process continues. Operation of the method may proceed to Step S440.

In Step S440, the first layer (or structure) may continue to be urged together with the second layer (or structure) such that at least a portion of a plurality of the excited Z-aligned fibers projecting from the first layer (or structure) may contact, or penetrate, the facing surface (and potentially a portion of the underlying structure) of the second layer (or structure) to thereby form a first mechanical bond between the first layer (or structure) and the second layer (or structure) based on the Z-aligned fiber contact or penetration. Operation of the method may proceed to Step S445.

In Step S445, the first layer (or structure) may continue to be urged together with the second layer (or structure) at least until the adhesive (or resin matrix) applied to the surface of the first layer (or structure) may contact the adhesive (or resin matrix) applied to the facing surface of the second layer (or structure), or contacts the facing surface of the second layer (or structure) directly, or the adhesive (or resin matrix) otherwise positioned between the first and second layers (or structures), to thereby form a second structural (adhesive or resin matrix) bond between the first layer (or structure) and the second layer (or structure) based on the qualities and characteristics of the adhesive (or resin matrix) to thereby complete the fabrication process of a complex composite structure. Operation the method may proceed to Step S450, where operation of the method ceases.

The exemplary depicted sequence of executable steps may represent one example of a corresponding sequence of acts for implementing the functions described in the steps of the above-outlined exemplary method. The exemplary depicted steps may be executed in any reasonable order to carry into effect the objectives of the disclosed embodiments. No particular order to the disclosed steps of the method is necessarily implied by the depiction in FIG. 4, except in the limited circumstances in which a particular method step in the sequence is a necessary precondition to execution of any other subsequent method step. Separately, not all of the depicted steps of the method shown in FIG. 4 are necessarily implemented in any particular embodiment.

FIGS. 5A and 5B respectively schematically illustrate a side view 500 and a front view 550 of details of an exemplary embodiment of an ultrasonic horn that may be usable according to this disclosure. In embodiments, an exemplary ultrasonic horn may comprise a plurality (or stack) of piezoelectric transducers 505-535 that may be usable to create minute, ultrasonic vibrations that may be applied to a material. No particular limiting configuration for the exemplary ultrasonic horn is to be considered to be implied the depictions in any of the Figures.

Although an exemplary embodiment of a usable ultrasonic horn comprising a stack of piezoelectric transducers 505-535 may be usable to create minute, ultrasonic vibrations that may be applied to a material, those of skill in the art of ultrasonic energy propagation will recognize that variations in the implementing technology may be undertaken to achieve the inventive objectives using myriad related implementing technologies, all of which should reasonably be understood to be encompassed by embodiments of the disclosed inventive concept.

Moreover, it should be recognized that other forms of external excitation forces may be introduced to the Z-aligned fibers such that the Z-aligned fibers may remain substantially vertically aligned, and may be vibrated, throughout the disclosed fabrication process.

Development of the disclosed embodiments identified key features that may be considered beneficial to performing the ultrasonic driving appropriate to excitation of the Z-aligned fibers. The inventors determined that a typical or conventional “standard” ultrasonic horn of a type usable for other ultrasonic applications including heating and/or welding may have been less than optimal for fully supporting the disclosed schemes as the standard ultrasonic horn may have been found, in instances, to (a) inconsistently apply the energy across the interstitial gap between layers so as to substantially uniformly excite, or vibrate, the Z-aligned fibers, (b) potentially create “hotspots” in the layer-to-layer or structure-to-structure bonding, and (c) run a risk of prematurely curing the adhesive or resin matrix layers prior to the layers or structures ultimately being urged, pressed, and/or bonded together. See, e.g. the discussion regarding FIGS. 2A-H above.

The standard, conventional ultrasonic horn may further be determined to be improved upon for applying energy to the large areas that are intended to be covered by the disclosed embodiment. Conventional ultrasonic horns are designed and optimized specifically, for example, for spot welding. In embodiments, a uniquely configured bar-type of ultrasonic horn may be optimally employed in a manner that avoids shortfalls of typical or conventional configuration, such as those enumerated above, or that may be discernable to those of skill in the art in implementing the objectives of the disclosed schemes, while maintaining, or even increasing an ability to cover large areas, and yet be conveniently handled, and/or adapted to the disclosed systems, methods, schemes, techniques and processes.

For example, in embodiments, the ultrasonic horn may be used as a compaction roller over a pi joint preform to excite the Z-aligned fibers allowing variations of the disclosed schemes to be equally effectively undertaken for many and widely varied vertical, horizontal and radius areas of pi joints in laminate composite structures of virtually any size, shape and external silhouette.

The above-described exemplary systems, methods, schemes, techniques and processes may be considered to reference certain conventional components to provide a brief, general description of suitable operating and fabrication method implementing environments in which the subject matter of this disclosure may be undertaken for familiarity and ease of understanding.

Those skilled in the art will appreciate that other embodiments of the disclosed subject matter may be practiced in myriad configurations for carrying into effect the disclosed systems, methods, schemes, techniques and processes in myriad ways and with myriad devices for urging individual layers toward one another and for fixing the individual layers to one another in a manner that the contact, or partial penetration, of the Z-aligned fibers of one layer with, or in, an opposing layer may supplement and strengthen the connective constructions between layers in a heretofore unforeseen and unforeseeable manner.

Although the above description may contain specific details as to one or more of the overall objectives of the disclosed schemes, and exemplary overviews of systems, methods, techniques and processes for carrying into effect those objectives, these details should be considered as illustrative only, and not construed as limiting the disclosure in any way. Other configurations of the described embodiments may properly be considered to be part of the scope of the disclosed exemplary embodiments. For example, the principles of the disclosed embodiments may be applied to each individual structure, identified groups of structures, or overall schemes of structures that may benefit individually through implementation of the disclosed solutions overall, or in discrete portions, as needed, according to one or more of the multiply discussed configurations. This enables each user to make full use of the benefits of the disclosed embodiments even if any one of a large number of possible applications do not require all of the described functionality. In other words, there may be multiple instances of the disclosed systems, methods, schemes, techniques and processes, each being separately employed in various possible ways at the same time, where the actions of one user may not necessarily affect the actions of other users using separate and discrete embodiments.

Other configurations of the described embodiments of the disclosed systems and methods are, therefore, part of the scope of this disclosure. It will be appreciated that various of the above-disclosed and other features and functions, or alternatives thereof, may be desirably combined into many other different systems or applications. Also, various alternatives, modifications, variations or improvements therein may be subsequently made by those skilled in the art, which are also intended to be encompassed by the following claims.

We claim:

1. A composite structure forming system, comprising:
a first platform for positioning a first laminate composite layer thereon, the first laminate composite layer comprising a plurality of Z-aligned fibers extending orthogonally from a plane of the first laminate composite layer;
a second platform for positioning a second laminate composite layer thereon, the second laminate composite layer positioned to face the first laminate composite layer, an adhesive layer being positioned between the first laminate composite layer and the second laminate composite layer;
an excitation force source that sis usable to apply an external excitation force to the plurality of Z-aligned fibers to maintain orthogonal alignment of the fibers with respect to the first laminate composite layer and the second laminate composite layer throughout a fabrication process;
wherein at least one of the first platform and the second platform is urged toward an other of the at least one of the first platform and the second platform to move the first laminate composite layer toward the second laminate composite layer at least until tips of the Z-aligned fibers contact the second laminate composite layer to form the composite structure.

2. The composite structure forming system of claim 1, the excitation force source comprising an ultrasonic energy emanating device that is usable to apply ultrasonic energy as the external excitation force.

3. The composite structure forming system of claim 2, the ultrasonic energy emanating device comprising a plurality of piezoelectric transducers usable to create ultrasonic vibrations applied to the plurality of Z-aligned fibers.

4. The composite structure forming system of claim 2, further comprising a processor that is configured to control at least one of an emitted power, wave form, frequency and exposure time of the ultrasonic energy applied by the ultrasonic energy emanating device.

5. The composite structure forming system of claim 4, the processor being further configured to control the urging the at least one of the first platform and the second platform toward the other.

6. The composite structure forming system of claim 2, at least a portion of the plurality of Z-aligned fibers being vibrated by the applied ultrasonic energy.

7. The composite structure forming system of claim 1, the urging the at least one of the first platform and the second platform toward the other continuing at least until tips of the Z-aligned fibers penetrate the second laminate composite layer to form the composite structure.

8. The composite structure forming system of claim 1, the urging the at least one of the first platform and the second platform toward the other continuing at least until the adhesive layer is sandwiched between facing surfaces of the first and second laminate composite layers to form the composite structure.

9. The composite structure forming system of claim 1, further comprising at least one heat applying device that applies heat to at least one of the first and second laminate composite layers via at least one of the first and second platforms.

10. The composite structure forming method of claim 9, the applied heat activating the adhesive layer between the first and second laminate composite layers to form the composite structure.

11. A composite structure forming method, comprising:
positioning a first laminate composite layer on a first platform, the first laminate composite layer comprising a plurality of Z-aligned fibers extending orthogonally from a plane of the first laminate composite layer;
positioning a second laminate composite layer on a second platform, the second laminate composite layer positioned to face the first laminate composite layer;
providing an adhesive layer between the first laminate composite layer and the second laminate composite layer;
applying an external excitation force to the plurality of Z-aligned fibers from an excitation force source to maintain orthogonal alignment of the fibers with respect to the first laminate composite layer and the second laminate composite layer throughout a fabrication process;
urging at least one of the first platform and the second platform toward an other of the at least one of the first platform and the second platform to move the first laminate composite layer toward the second laminate composite layer at least until tips of the Z-aligned fibers contact the second laminate composite layer to form the composite structure.

12. The composite structure forming method of claim 11, the excitation force source comprising an ultrasonic energy emanating device that is usable to apply ultrasonic energy as the external excitation force.

13. The composite structure forming method of claim 12, the ultrasonic energy emanating device comprising a plurality of piezoelectric transducers usable to create ultrasonic vibrations applied to the plurality of Z-aligned fibers.

14. The composite structure forming method of claim 12, further comprising controlling, with a processor, at least one of an emitted power, wave form, frequency and exposure time of the ultrasonic energy applied by the ultrasonic energy emanating device.

15. The composite structure forming method of claim 14, the processor being further configured to control the urging the at least one of the first platform and the second platform toward the other.

16. The composite structure forming method of claim 12, at least a portion of the plurality of Z-aligned fibers being vibrated by the applied ultrasonic energy.

17. The composite structure forming method of claim 11, the urging the at least one of the first platform and the second platform toward the other continuing at least until tips of the Z-aligned fibers penetrate the second laminate composite layer to form the composite structure.

18. The composite structure forming method of claim 11, the urging the at least one of the first platform and the second platform toward the other continuing at least until the adhesive layer is sandwiched between facing surfaces of the first and second laminate composite layers to form the composite structure.

19. The composite structure forming method of claim 11, further comprising applying heat to at least one of the first and second laminate composite layers via at least one of the first and second platforms with at least one heat applying device.

20. The composite structure forming method of claim 19, the applied heat activating the adhesive layer between the first and second laminate composite layers to form the composite structure.
